(19) United States
(12) Patent Application Publication
(10) Pub. No.: US 2015/0310479 A1
(43) Pub. Date: Oct. 29, 2015

(54) PROCESS FOR SYNCHRONIZING AUDIO PLAYBACK ON A SMARTPHONE WITH CONTENT DISPLAYED ON A DIGITAL SIGN

(71) Applicant: Panasonic Automotive Systems Company of America, Division of Panasonic Corporation of North America, PEACHTREE CITY, GA (US)

(72) Inventors: ADEEL YUSUF, ATLANTA, GA (US); JOHN AVERY, NEWNAN, GA (US)

(73) Assignee: Panasonic Automotive Systems Company of America, Division of Panasonic Corporation of North America

(21) Appl. No.: 14/695,451

(22) Filed: Apr. 24, 2015

Related U.S. Application Data
(60) Provisional application No. 61/984,480, filed on Apr. 25, 2014.

(51) Int. Cl. G06Q 30/02; H04N 5/06; H04W 4/02

(52) U.S. Cl. CPC G06Q 30/0241; H04W 4/02; H04N 5/06

(57) ABSTRACT

A method of operating a plurality of signboards includes continuously displaying a current time-of-day on the signboards. A request is received from a smartphone for an audio clip corresponding to one of the signboards. The request includes the displayed time-of-day as captured from the one signboard by a camera of the smartphone. The request also includes a geographic location of the smartphone. It is determined that the one signboard is within a visible range of the smartphone. The determining is performed dependent upon the geographic location of the smartphone. The audio clip corresponding to the one signboard is selected from a plurality of audio clips. The selecting is performed dependent upon the determination that the one signboard is within a visible range of the smartphone and upon the displayed time-of-day. At least a portion of the selected audio clip is downloaded to the smartphone.

### CROSS-REFERENCE TO RELATED APPLICATIONS

This application claims the benefit of U.S. Provisional Application No. 61/984,480 filed on Apr. 25, 2014, which the disclosure of which is hereby incorporated by reference in its entirety for all purposes.

### BACKGROUND OF THE INVENTION

1. Field of the Invention

The present invention relates to electronic billboards, and, more particularly, to presenting digital information in conjunction with an electronic billboard.

2. Description of the Related Art

Currently, the digital signage solutions available in the market are not accompanied by audio. The information that the viewer can obtain is limited to the images displayed on the digital signs.

### SUMMARY OF THE INVENTION

The invention may provide a method for synchronizing a message/video displayed on a digital sign board with an audio channel of a smartphone by using a combination of optical image processing, optical character recognition, a timestamp in the audio channel, and the actual time displayed on the board. A time-of-day may be indicated on the signboard by numbers or by a Quick Response code, for example.

The invention utilizes smartphone technology to enable images on signboards to be accompanied by audio messages. The high resolution of modern digital signs along with cameras on smartphones are combined to synchronize the audio with the video displayed on the sign. The audio data may be predownloaded from the application server multimedia database to the smartphone based on the current geographic GPS coordinate location of the smartphone.

The invention may enable the synchronous playback of the audio on the smartphone with the video of the digital sign.

The invention comprises, in one form thereof, a method of operating a plurality of signboards, including continuously displaying a current time-of-day on the signboards. A request is received from a smartphone for an audio clip corresponding to one of the signboards. The request includes the displayed time-of-day as captured from the one signboard by a camera of the smartphone. The request also includes a geographic location of the smartphone. It is determined that the one signboard is within a visible range of the smartphone. The determining is performed dependent upon the geographic location of the smartphone. The audio clip corresponding to the one signboard is selected from a plurality of audio clips. The selecting is performed dependent upon the determination that the one signboard is within a visible range of the smartphone and upon the displayed time-of-day. At least a portion of the selected audio clip is downloaded to the smartphone.

The invention comprises, in another form thereof, a method of operating a plurality of signboards, including receiving a request from a smartphone for an audio clip corresponding to one of the signboards. The request includes a geographic location of the smartphone, and a cardinal direction in which a camera on the smartphone is directed. It is determined, dependent upon the geographic location of the smartphone that the one signboard is within a visible range of the smartphone. It is ascertained, dependent upon the cardinal direction in which the camera on the smartphone is directed, that the one signboard may be within the field of view of the camera. The audio clip corresponding to the one signboard is selected from a plurality of audio clips. The selecting is dependent upon the determining step and upon the ascertaining step. The selected audio clip is downloaded to the smartphone.

The invention comprises, in yet another form thereof, a method of operating a signboard, including receiving from a motor vehicle a geographic location of the vehicle and a cardinal heading direction of the vehicle. A signboard that is visible to a person within the vehicle is identified dependent upon the geographic location of the vehicle and the cardinal heading direction of the vehicle. An audio clip corresponding to the signboard is selected from a plurality of audio clips dependent upon the identifying step and upon a time-of-day. The selected audio clip is downloaded to the vehicle.

An advantage of the present invention is that audio playback files may capture a user's attention better than a signboard alone, and may bring the signboard to the user's attention.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a synchronized audio digital signboard arrangement of the present invention.

FIG. 2 is a plot illustrating the visible ranges of a plurality of signboards relative to a location of a user and his smart phone.

FIG. 3 is a table illustrating an audio clip selection database of the present invention.

FIG. 4 is a block diagram of another embodiment of a synchronized audio digital signboard arrangement of the present invention.

### DETAILED DESCRIPTION

### Glossary

Smartphone—a cellular phone that performs many of the functions of a computer, typically having a touchscreen interface, Internet access, and an operating system capable of running downloaded applications.

QR Code—a type of matrix barcode (or two-dimensional barcode). A barcode is a machine-readable optical label that contains information about the item to which it is attached.

Timestamp—a sequence of characters or encoded information associated with a time an event has occurred or will occur, or with a time duration of the event,

The embodiments hereinafter disclosed are not intended to be exhaustive or limit the invention to the precise forms disclosed in the following description. Rather the embodiments are chosen and described so that others skilled in the art may utilize its teachings.

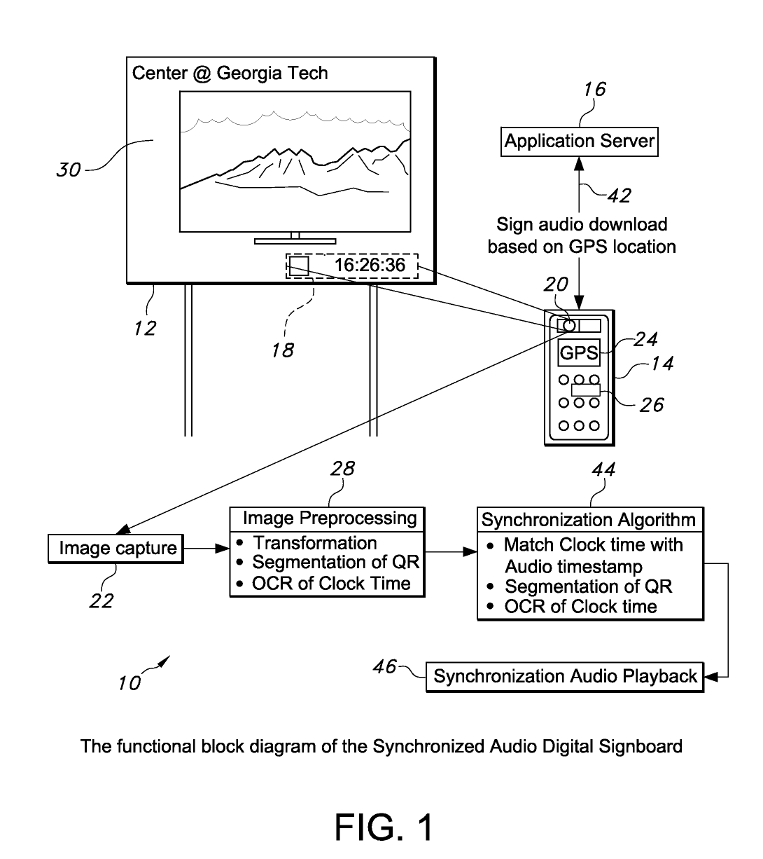

FIG. 1 is a block diagram of one embodiment of a synchronized audio digital signboard arrangement 10 of the present invention. Arrangement 10 includes a digital signboard or billboard 12, a smart phone 14, and an application server 16. Billboard 12 has a designated area 18 in which the actual current time of day and a Quick Response Code (QR code) are displayed.

Smart phone 14 includes a camera 20 which the user may point at billboard 12 and capture an image thereof, as indicated at 22. Phone 14 also includes a GPS module 24 that determines the geographical coordinates of phone 14, as is well known.

Phone 14 further includes an image processor 26 that processes images captured by camera 20. More particularly, as indicated at 28, processor 26 may transform the image displayed on billboard 12, including both the image within area 18 and the image within a remaining area 30 on billboard 12. The transformation of the image within area 18 may include segmentation of the QR code in order to decode the information encoded within the QR code. More generally, “segmentation.” may refer to the process of assigning a label or value to each pixel within an image such that pixels having equivalent labels or values also have equivalent visual characteristics. In this case, the QR code may specify the content displayed within area 18. For example, there may be a number of billboards displayed around the world or around the country that display the same content (e.g., “Panasonic”), and each of these billboards may share the same identification QR code. The transformation of the image within area 18 performed by image processor 26 may also include optical character recognition (OCR) to determine the time of day or clock time that is displayed within area 18.

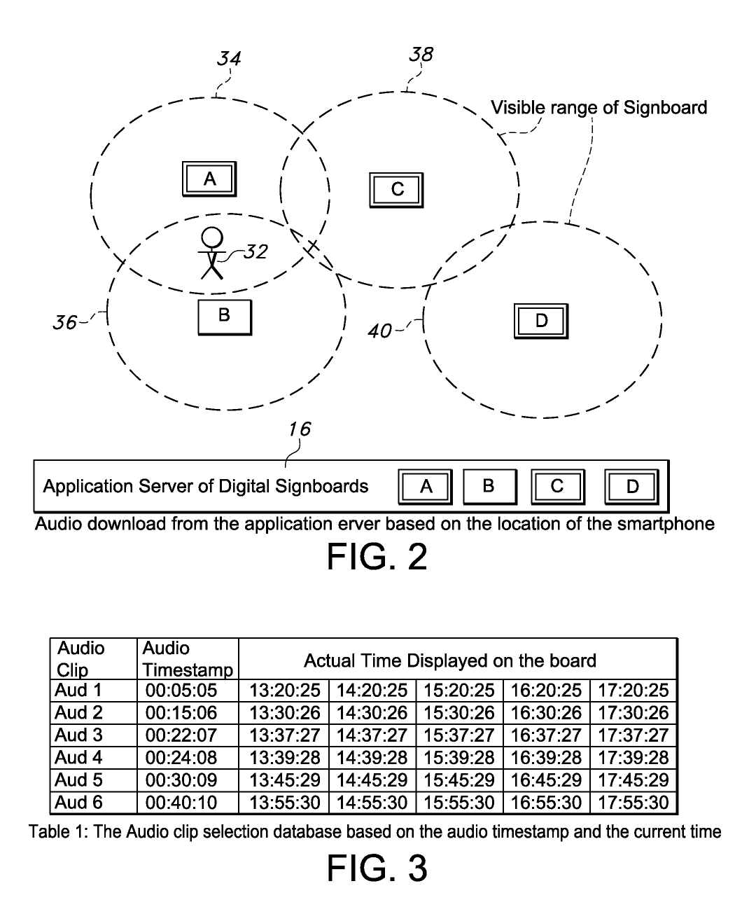

After camera 20 has captured the image of the billboard, GPS 24 may determine the geographical coordinates of phone 14. Application server 16 may include a database specifying which billboards are visible at any location or set of geographical coordinates. For example, FIG. 2 illustrates the location of a user 32 located at X degrees longitude and Y degrees latitude, as determined by GPS 24. The visible range of billboard A is represented by the dashed closed loop boundary 34; the visible range of billboard B is represented by the dashed closed loop boundary 36; the visible range of billboard C is represented by the dashed closed loop boundary 38; and the visible range of billboard D is represented by the dashed closed loop boundary 40. As is evident from user 32 being within both boundaries 34 and 36 in FIG. 2, user 32 is within the visible range of billboards A and B, but is not within the visible range of billboards C and D. Thus, the audio clips or audio files associated with billboards A and B may be downloaded from application server 16 to phone 14, as indicated at 42, based on the GPS-determined location of phone 14.

It is also possible in one embodiment for phone 14 to include a compass application that determines in which cardinal direction camera 20 is pointed. Then only the audio clips or files associated with the signboard at which camera 20 is pointed may need to be downloaded to phone 14.

In one embodiment, geographic locations of the signboards may be determined in order to ascertain which, if any, signboard is within the field of view of the smartphone camera, or within the field of view of the humans within the vehicle, given the geographic locations of the camera or vehicle, and possibly the direction in which the camera is pointed. The geographic location of each signboard may be found in a lookup table maintained by the application server, or may be determined in real time by GPS devices associated with each respective signboard.

FIG. 3 is a table illustrating the selection of an audio clip from a database of audio clips associated with a particular signboard. The selection of the audio clip may be dependent upon a schedule of video images displayed on the signboard and corresponding audio clips associated with the video images. In the embodiment of FIG. 3, the selection of one of the six audio clips in the database may be based on the current time displayed in area 18 and on respective audio timestamps associated with each of the audio clips. More particularly, as indicated at 44, the clock time displayed in area 18 may be matched with the audio timestamp. As also indicated at 44, this matching of the clock time with the timestamp may be facilitated by the segmentation of the QR code and the OCR of the displayed clock time. For example, the QR code may indicate the current time, or may possibly identify the audio clip that is associated with the current display.

As an example of how the table of FIG. 3 may be used, if camera 20 senses that the actual time displayed on area 18 is 13:20:25, then phone 14 downloads audio clip 1 and begins synchronized audio playback, as indicated at 46, at the beginning of audio clip 1. If instead camera 20 senses that the actual time displayed on area 18 is 13:30:26, then phone 14 downloads audio clip 2 and begins playback at the beginning of audio clip 2. However, if the actual time displayed on area 18 is in-between the actual times in FIG. 3, as is more likely the case, then phone 14 downloads the audio clip associated with the most recent time found in FIG. 3 and begins playback of the clip at a point that corresponds to the actual time displayed on area 18. For example, if the actual time displayed on area 18 is 14:50:29, then phone 14 downloads audio clip 5 and begins playback about half-way through the clip. As another example, if the actual time displayed on area 18 is 17:41:29, then phone 14 downloads audio clip 4 and begins playback about one-third of the way through the clip.

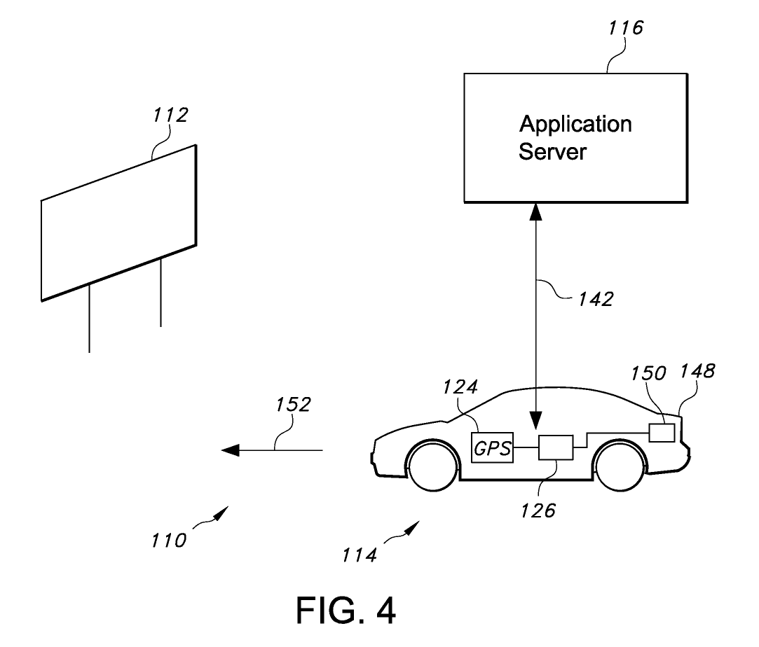

FIG. 4 is a block diagram of another embodiment of a synchronized audio digital signboard arrangement 110 of the present invention. Arrangement 110 includes a digital billboard 112, vehicle electronics 114 disposed within a motor vehicle 148, and an application server 116.

Vehicle electronics 114 includes a GPS module 124 that determines the geographical coordinates of phone 14, as is well known; a compass device 150 that determines a direction 152 in which vehicle 148 is headed or facing; and a radio processor 126 that receives the geographical location information from GPS 124 and the direction information from compass device 150. Radio processor 126 uploads the geographical location information and the direction information to application server 116, as indicated at 142. Application server 116 may download a satellite radio service to radio processor 126 for audibly playing on loudspeakers (not shown) within vehicle 148.

During use, when the satellite radio service programming reaches a commercial break, application service 116 may determine, based on the geographical location information and the direction information associated with vehicle 148, whether people within vehicle 148 are likely to be able to see and recognize what is being displayed on billboard 112. If it is determined that people within vehicle 148 are likely to be able to see and recognize what is being displayed on billboard 112, then the satellite radio service may download to radio processor 126 an audio clip that corresponds to the images displayed on billboard 112 rather than the audio commercial that would otherwise be downloaded to radio processor 126. Application service 116 may determine, based on the time-of-day, what images are being displayed on billboard 112, and what audio clip corresponds to the images and thus should be downloaded to radio processor 126 for playing within vehicle 148.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of operating a plurality of signboards, the method comprising the steps of:
continuously displaying a current time-of-day on the signboards;
receiving a request from a smartphone for an audio clip corresponding to one of the signboards, the request including:
the displayed time-of-day as captured from the one signboard by a camera of the smartphone; and
a geographic location of the smartphone;
determining that the one signboard is within a visible range of the smartphone, the determining being dependent upon the geographic location of the smartphone;
selecting the audio clip corresponding to the one signboard from a plurality of audio clips, the selecting being dependent upon the determining step and upon the displayed time-of-day; and
downloading at least a portion of the selected audio clip to the smartphone.

2. The method of claim 1 wherein the time-of-day is displayed in the form of numbers, and further comprising receiving from the smartphone a result of the smartphone performing optical character recognition on the displayed numbers.

3. The method of claim 1 wherein the time-of-day is displayed in the form of a Quick Response code that is captured by the smartphone.

4. The method of claim 1 further comprising ascertaining a direction in which the camera of the smartphone is directed, the determining that the one signboard is within a visible range of the smartphone being dependent upon the ascertained direction.

5. The method of claim 1 wherein the selecting step is dependent upon a schedule of video images displayed on the signboard and corresponding audio clips associated with the images.

6. The method of claim 1 wherein the selecting step is dependent upon a plurality of audio timestamps, wherein each of the audio clips is associated with a respective one of the audio timestamps.

7. The method of claim 1 wherein the smartphone begins playback of the selected audio clip at a point that corresponds to the displayed time-of-day.

8. A method of operating a plurality of signboards, the method comprising the steps of:
receiving a request from a smartphone for an audio clip corresponding to one of the signboards, the request including:
a geographic location of the smartphone; and
a cardinal direction in which a camera on the smartphone is directed;
determining that the one signboard is within a visible range of the smartphone, the determining being dependent upon the geographic location of the smartphone;
ascertaining that the one signboard may be within the field of view of the camera, the ascertaining being dependent upon the cardinal direction in which the camera on the smartphone is directed;
selecting the audio clip corresponding to the one signboard from a plurality of audio clips, the selecting being dependent upon the determining step and upon the ascertaining step; and
downloading the selected audio clip to the smartphone.

9. The method of claim 8 further comprising:
displaying a time-of-day in the form of numbers on the signboard; and
receiving from the smartphone an identification of the displayed numbers.

10. The method of claim 8 further comprising:
displaying a time-of-day is in the form of a Quick Response code on the signboard; and
receiving from the smartphone an identification of the time-of-day represented by the Quick Response code.

11. The method of claim 8 further comprising determining a geographic location of the one signboard, the determining that the one signboard is within a visible range of the smartphone being dependent upon the geographic location of the one signboard.

12. The method of claim 8 wherein the selecting step is dependent upon a schedule of video images displayed on the signboard and corresponding audio clips associated with the images.

13. The method of claim 8 wherein the selecting step is dependent upon a plurality of audio timestamps, wherein each of the audio clips is associated with a respective one of the audio timestamps.

14. The method of claim 8 wherein the smartphone begins playback of the selected audio clip at a point that corresponds to a time-of-day indicated on the one signboard.

15. The method of claim 8 further comprising displaying on the one signboard a Quick Response code indicating an audio clip currently associated with images being presented on the signboard

16. A method of operating a signboard, the method comprising the steps of:
receiving from a motor vehicle:
a geographic location of the vehicle; and
a cardinal heading direction of the vehicle;
identifying a signboard that is visible to a person within the vehicle, the identifying being dependent upon the geographic location of the vehicle and the cardinal heading direction of the vehicle;
selecting an audio clip corresponding to the signboard from a plurality of audio clips, the selecting being dependent upon the identifying step and upon a time-of-day; and
downloading the selected audio clip to the vehicle.

17. The method of claim 16 further comprising determining a geographic location of the signboard, the identifying a signboard that is visible to a person within the vehicle being dependent upon the geographic location of the signboard.

18. The method of claim 16 wherein the selecting step is dependent upon a schedule of video images displayed on the signboard and corresponding audio clips associated with the images.

19. The method of claim 16 wherein the selecting step is dependent upon a plurality of audio timestamps, wherein each of the audio clips is associated with a respective one of the audio timestamps.

20. The method of claim 16 wherein the playback of the selected audio clip is begun in the vehicle at a point that corresponds to the time-of-day.
